(19) United States
(12) Patent Application Publication
(10) Pub. No.: US 2018/0042805 A1
(43) Pub. Date: Feb. 15, 2018

(54) ETHERNEYE MASSAGER

(71) Applicant: Bridge Technology Co., Ltd., TAICHUNG CITY (TW)

(72) Inventor: Yuan-Tsang Lin, Taichung City (TW)

(73) Assignee: Bridge Technology Co., Ltd., TAICHUNG CITY (TW)

(21) Appl. No.: 15/648,468

(22) Filed: Jul. 13, 2017

(30) Foreign Application Priority Data
Aug. 10, 2016 (TW) 105125453

(51) Int. Cl. A61H 9/00

(52) U.S. Cl. CPC A61H 9/0057; A61H 2201/0157; A61H 2201/1238; A61H 2201/1604; A61H 2201/165; A61H 2201/5056; A61H 2205/024

(57) ABSTRACT

An eye massager being able to massage the five acupuncture-points and effectively relieve fatigue of eyes including a case, a flexible light transmissive film disposed in the case and a pressure controller is provided. The case includes an accommodation space where the pressure controller disposed in and a pressure control space formed by the flexible light transmissive film covering part of the case. When the case covers the eyes, the case, the flexible light transmissive film and the eyes form a sealed space. When the pressure controller adapted to detect and adjust a magnitude of a pressure in the pressure control space lowers the pressure, the flexible light transmissive film depresses towards the pressure control space to increase a volume of the sealed space. When the pressure controller fills a gas into the pressure control space, the flexible light transmissive film protrudes towards the sealed space and presses the eyes.

### CROSS-REFERENCE TO RELATED APPLICATION

This application claims the priority benefit of Taiwan application serial no. 105125453, filed on Aug. 10, 2016. The entirety of the above-mentioned patent application is hereby incorporated by reference herein and made a part of this specification.

### BACKGROUND OF THE INVENTION

### 1. Field of the Invention

The invention relates to a massage apparatus. More particularly, the invention relates to an eye massager.

### 2. Description of Related Art

With increasing dependency and time spent on electronic products, people's vision problems have gradually worsened. In order to adjust, for example, a pupillary distance between the eye balls and correct vision problems generated from abnormal diopter of cornea, wearing a pair of glasses is the most common way to solve such problems. Nevertheless, although vision may be restored through wearing the glasses and lenses, it is a rather negative way of visual correction, and fatigue and stress felt by the user generated from the eye balls themselves are yet to be improved.

In existing technologies, a type of massager is developed, in which positive and negative pressures are alternatively exchanged for performing pressure suction to the eye balls for achieving eye relaxation, so as to massage and treat the pupillary distance between the eye balls. Nevertheless, in practical use, a motor is rotated to drive a control disk, and then a turning shaft detent actuator on one side of the control disk actuates back and forth, such that the positive and the negative pressures are generated in the massager. Consequently, through adopting such an indirect motor convex wheel operating mechanism, a structure of the massager become complex, and an overall volume of the massager is considerably increased. On the other hand, pressure detection is further required to rotate the motor; and since a pressure detection element and a motor have to be disposed, overall complexity of the elements and manufacturing costs of the foregoing vision massager are increased.

### SUMMARY OF THE INVENTION

The invention provides an eye massager which is able to more effectively massage and relax the eyes of a user.

An eye massager of the embodiments of the invention is adapted to massage eyes of a user. The eye massager includes a case, a flexible light transmissive film, and a pressure controller. The case includes an accommodation space and a pressure control space. The flexible light transmissive film is disposed in the case, and the flexible light transmissive film covers part of the case to form the pressure control space. The pressure controller is disposed in the accommodation space, and the pressure controller is adapted to detect and adjust a magnitude of a pressure in the pressure control space. When the case covers the eyes of the user, a sealed space is formed among the case, the flexible light transmissive film, and the eyes of the user. Moreover, a size of the pressure control space may compress or extract the sealed space. When the pressure controller lowers the pressure in the pressure control space, the flexible light transmissive film depresses towards the pressure control space, a volume of the sealed space is increased, and the eyes of the user are thus sucked towards the sealed space. When the pressure controller fills gas into the pressure control space, the flexible light transmissive film protrudes towards the sealed space and presses the eyes of the user, and then the pressure control space compresses the sealed space and the eyes of the user.

In an embodiment of the invention, the eye massager further includes an elastic protection frame surrounding one end of the case. The elastic protection frame is adapted to be in contact with and surround around the eyes of the user, and the sealed space is thus formed.

In an embodiment of the invention, the eye massager further includes a light emitting element. The light emitting element is disposed in the accommodation space, and a light beam emitted by the light emitting element is adapted to pass through the flexible light transmissive film.

In an embodiment of the invention, the eye massager further includes a processor connected to the pressure controller. The processor sends a control signal to the pressure controller according to the magnitude of the pressure detected by the pressure controller and thus further adjusts the pressure in the pressure control space.

In an embodiment of the invention, when the eye massager covers the eyes of the user, the flexible light transmissive film is located between the case and the eyes of the user.

To sum up, the eye massager of the embodiments of the invention is adapted to extract gas from or fill gas into the pressure control space through the pressure controller and simultaneously detects the pressure in the pressure control space, so as to instantaneously determine operations of the pressure controller according to the pressure in the pressure control space and thus effectively massage the eyes of the user.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an eye massager according to the first embodiment of the invention.

FIG. 2A to FIG. 2C are schematic cross-sectional views of an eye massager according to the first embodiment of the invention.

FIG. 3 is a schematic perspective view of an eye massager according to the first embodiment of the invention.

### DESCRIPTION OF THE EMBODIMENTS

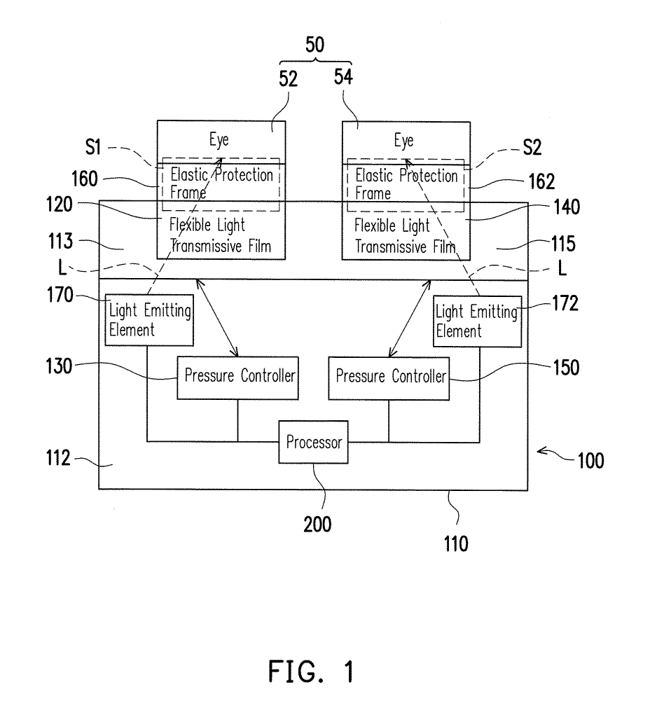

The invention provides an eye massager which is able to more effectively massage eyes of a user. Referring to FIG. 1, in the first embodiment of the invention, an eye massager 100 includes a case 110, flexible light transmissive films 120 and 140, and pressure controllers 130 and 150. The case 110 includes an accommodation space 112 and pressure control spaces 113 and 115. Moreover, the pressure controllers 130 and 150 and light emitting elements 170 and 172 are disposed in the accommodation space 112, the flexible light transmissive film 120 is disposed in the pressure control space 113, and the flexible light transmissive film 140 is disposed in the pressure control space 115.

In the present embodiment, the flexible light transmissive film 120 is disposed on one side of the pressure control space 113 adjacent to a user 50 such that the pressure control space 113 is formed, and the flexible light transmissive film 140 is disposed on one side of the pressure control space 115 adjacent to the user 50 such that the pressure control space 115 is formed. The pressure controller 130 is configured to detect a magnitude of a pressure in the pressure control space 113 and controls the magnitude of the pressure through extracting gas from or pumping gas into the pressure control space 113. A pressure in the pressure control space 115 is adjusted and detected by the pressure controller 150.

When the case 110 covers eyes 52 and 54 of the user 50, a sealed space Si is formed between the case 110 and the eye 52, and moreover, the flexible light transmissive film 120 is adjacent to the eye 52, such that a size of the pressure control space 113 may compress or extract the sealed space S1. Simultaneously, a sealed space S2 is formed between the case 110 and the eye 54, such that a size of the pressure control space 115 may compress or extract the sealed space S2, and the flexible light transmissive film 140 is adjacent to the eye 54. When the pressure controllers 130 and 150 lower the pressures in the pressure control spaces S1 and S2, the flexible light transmissive films 120 and 140 depress towards the pressure control spaces 113 and 115, volumes of the sealed spaces S1 and S2 are thereby increased, and the eyes of the user 50 are sucked towards the sealed spaces S1 and S2. When the pressure controllers 130 and 150 increase the pressures in the pressure control spaces S1 and S2, the flexible light transmissive films 120 and 140 protrude towards the sealed spaces S1 and S2 and further press the eyes 52 and 54 of the user 50, as such, the pressure control spaces 113 and 115 compress the sealed spaces S1 and S2 and the eyes 52 and 54.

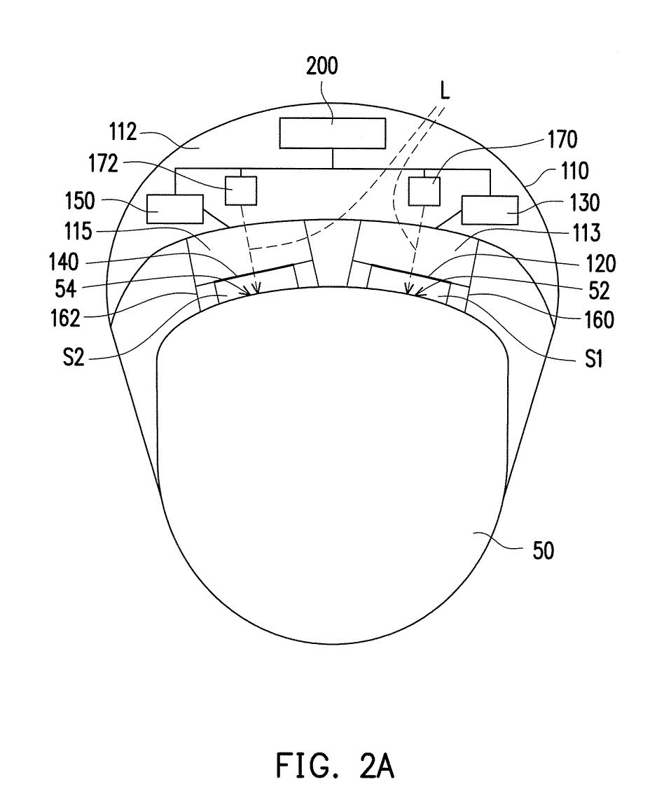

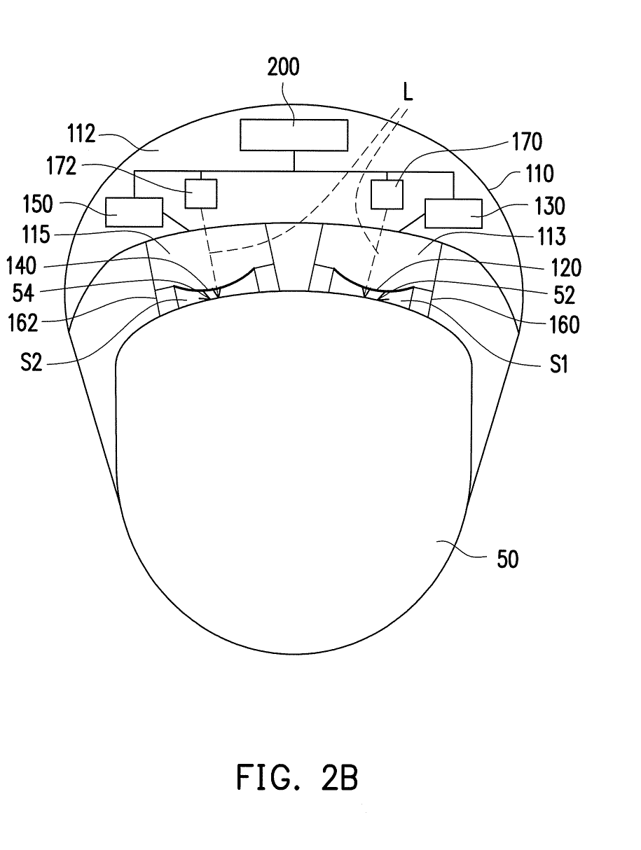

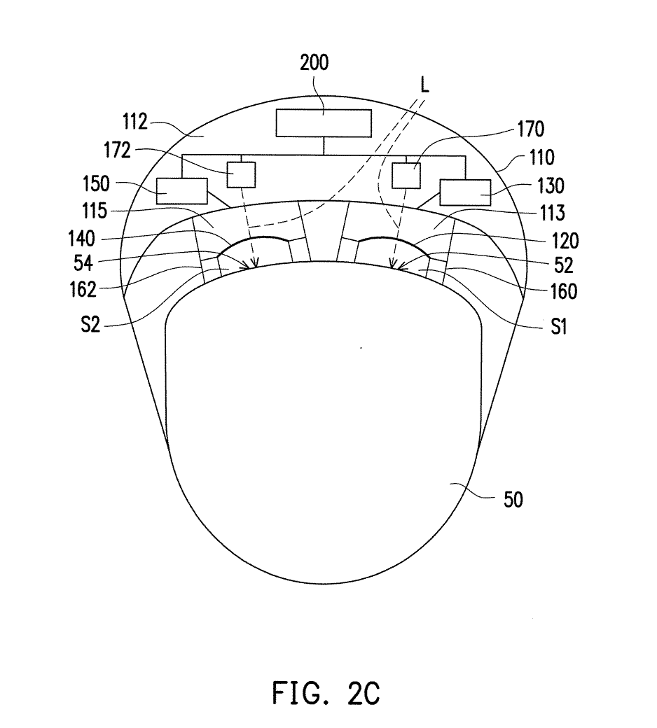

Specifically, FIG. 2A to FIG. 2C are schematic cross-sectional views of an eye massager according to the first embodiment of the invention. Referring to FIG. 1 and FIG. 2A, in the first embodiment of the invention, the flexible light transmissive films 120 and 140 are disposed in the case 110. The flexible light transmissive film 120 covers part of the case 110 to form the pressure control space 113, and the flexible light transmissive film 140 covers part of the case 110 to faun the pressure control space 115. The pressure controllers 130 and 150 are disposed in the accommodation space 112 of the case 110.

In other words, the flexible light transmissive film 120 seals one end of the pressure control space 113, and the amount of gas in the pressure control space 113 is changed by the pressure controller 130. The flexible light transmissive film 140 seals one end of the pressure controller 150, and the amount of gas in the pressure control space 115 is changed by the pressure controller 150.

When the case 110 of the present embodiment covers the eyes 52 and 54 of the user 50, the sealed spaces S1 and S2 are respectively formed among the case 110, the flexible light transmissive film 120, and the eyes 52 and 54 of the user 50.

Referring to FIG. 1 and FIG. 2B, when the pressure controllers 130 and 150 respectively fill gas into the pressure control spaces 113 and 115, the flexible light transmissive films 120 and 140 respectively protrude towards the sealed spaces S1 and S2 and thus press the eyes 52 and 54 of the user 50. In other words, when the pressure controllers 130 and 150 fill gas into the pressure control spaces 113 and 115, the flexible light transmissive films 120 and 140 sealing the pressure control spaces 113 and 115 protrude and press the eyes 52 and 54 of the user 50.

Referring to FIG. 1 and FIG. 2C, when the pressure controller 130 lowers the pressure in the pressure control space 113, the flexible light transmissive film 120 depresses towards the pressure control space 113, and that the volume of the sealed space S1 is increased. In the pressure controller 150, the flexible light transmissive film 140 depresses towards the pressure control space 115 through lowering the pressure in the pressure control space 115 such that the volume of the sealed space S2 is increased. As the volume of the sealed space S1 increases, the pressure in the sealed space S1 is lowered relatively such that the eye 52 of the user 50 is sucked towards the pressure control space 113. Simultaneously, the pressure in the sealed space S2 is lowered owing to volume increase as well, and the eye 54 of the user 50 is thereby sucked.

Therefore, in the present embodiment, the eye massager 100 may adjust the magnitudes of the pressures back and forth to massage the eyes 52 and 54 of the user 50 through the pressure controllers 130 and 150. Since the pressure controllers 130 and 150 of the eye massager 100 can simultaneously adjust and detect the pressures in the pressure control spaces 113 and 115, how the pressure controllers 130 and 150 adjust the pressures may be determined more effectively according to the magnitudes of the pressures. On the other hand, the pressure controllers 130 and 150 may be directly disposed in the accommodation space 112 of the case 110, an overall volume of the eye massager 100 can thus be reduced.

In other words, when the eye massager 100 covers the eyes 52 and 54 of the user 50, the flexible light transmissive films 120 and 140 are located between the case 110 and the eyes 52 and 54 of the user 50. As such, pressures around the eyes of the user 50 can change along with bending of the flexible light transmissive films 120 and 140.

Specifically, the foregoing eye massager 100 further includes a processor 200 connected to the pressure controllers 130 and 150. The processor 200 sends a control signal to the pressure controllers 130 and 150 according to the magnitudes of the pressures detected by the pressure controllers 130 and 150, thereby adjusting the pressures in the pressure control spaces 113 and 115.

For instance, the processor 200, for example, may determine a maximum value of pressure during gas filling according to a pressure change when the pressure controllers 130 and 150 fill gas into the pressure control spaces 113 and 115 or may determine a minimum value of pressure during gas extraction according to a pressure change when the pressure controllers 130 and 150 extract gas from the pressure control spaces 113 and 115.

The pressure controllers 130 and 150 of the present embodiment are a type of pressure transducers. For instance, the pressure controllers 130 and 150, for example, are pressure transducers suitable for biomedical science, meteorology, and other areas. A core of such pressure transducer is a pressure transducer chip technically processed using the microelectromechanical systems (MEMS). The pressure transducer chip is formed by an elastic membrane and four electrical resistances integrated on the membrane. The four electrical resistances, for example, may be formed by piezoelectric materials, and thus the Wheatstone bridge structure is formed. As such, when a pressure is applied onto the elastic membrane, the bridge generates a voltage output signal in linear proportion to the pressure applied. Therefore, the overall volume of the eye massager 100 can be significantly reduced.

The pressure controllers of the embodiments of the invention are not limited to the foregoing arrangement. In other embodiments of the invention, the pressure controllers may further include a gas pump motor or a vacuum motor suitable for controlling gas flowing in and out of the pressure control space. The invention is not limited thereto.

On the other hand, a material of the flexible light transmissive films 120 and 140 provided by the first embodiment of the invention is, for example, silicone. As such, the flexible light transmissive films 120 and 140 are suitable for being in contact with the eyes 52 and 54 of the user 50, and that the user 50 will not feel uncomfortable when being massaged.

The eye massager 100 of the present embodiment further includes elastic protection frames 160 and 162 surrounding one end of the case 110. The elastic protection frames 160 and 162 are adapted to be in contact with and surround around the eyes 52 and 54 of the user 50, and the sealed spaces Si and S2 are thus formed. Specifically, the elastic protection frames 160 and 162 of the present embodiment protrude from portions of the case 110 forming the pressure control spaces 113 and 115. Moreover, a material of the elastic protection frames 160 and 162 is, for example, silicone. As such, when the user 50 wears the eye massager 100, the elastic protection frames 160 and 162 may lean against the skin around the eyes 52 and 54 of the user 50. The elasticity of the elastic protection frames 160 and 162 may further ensure that the sealed spaces S1 and S2 are sealed, and that the pressure control spaces 113 and 115 may effectively drive the volumes and sizes of the sealed spaces S1 and S2.

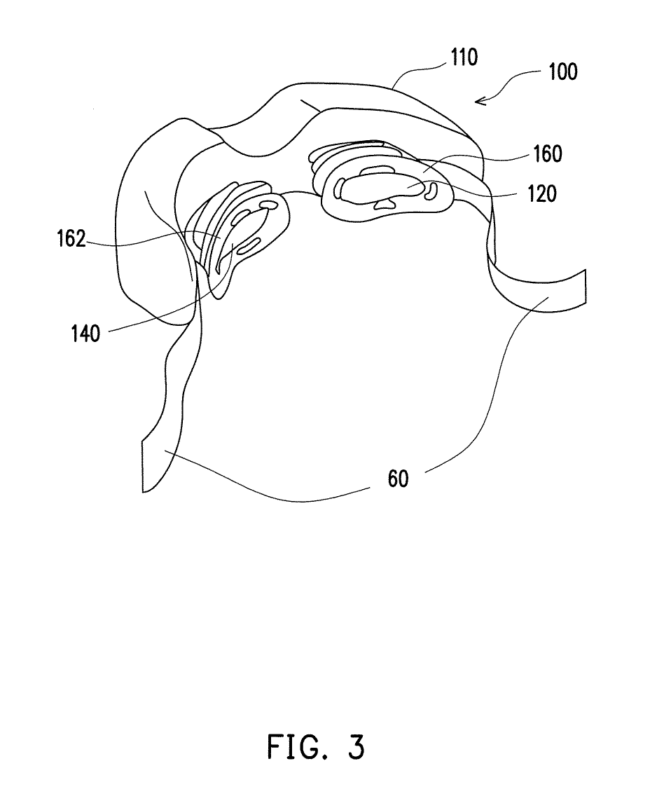

FIG. 3 is a schematic perspective view of an eye massager according to the first embodiment of the invention. Referring to FIG. 3, in the present embodiment, the eye massager 100 may further includes a head band 60. The head band 60 is suitable for being in contact with the head of the user 50, such that the case 110 and the elastic protection frames 160 and 162 of the eye massager 100 may properly press the eyes 52 and 54 of the user 50 and to further control a pressure around the eyes 52 and 54 through the flexible light transmissive films 120 and 140. On the other hand, the eye massager 100 of the present embodiment may be used more conveniently when a gas pipeline and an electrical connecting circuit are both disposed in the case 110. But the invention is not limited thereto. In other embodiments of the invention, the eye massager may also be connected to external electronic elements through additional gas pipelines and electrical connecting circuits.

On the other hand, the elastic protection frame 160 is fixed and connected to the flexible light transmissive film 120 and the case 110, and the elastic protection frame 162 is fixed and connected to the flexible light transmissive film 140 and the case 110. In other words, since the elastic protection frames 160 and 162 are sleeved on the case 110, the flexible light transmissive films 120 and 140 may respectively be sandwiched between the elastic protection frames 160 and 162 and the case 110.

The eye massager 100 of the present embodiment further includes light emitting elements 170 and 172. The light emitting elements 170 and 172 are disposed in the accommodation space 112, and a light beam L emitted by the light emitting elements 170 and 172 is adapted to pass through the flexible light transmissive films 120 and 140. As such, when the user 50 wears the eye massager 100, the eyes 52 and 54 can both receive the light beam L.

Specifically, the light beam emitted by the light emitting elements 170 and 172, for example, is a green light beam with a wavelength ranges between 495 nanometers and 570 nanometers. Therefore, the eye massager 100 of the present embodiment may massage the eyes 52 and 54, and that a stress felt by the user 50 is released simultaneously.

In view of the foregoing, in the embodiments of the invention, the pressure controllers may be directly disposed in the case of the eye massager, and the flexible light transmissive films are adapted to cover the eyes of the user to form the sealed spaces. When the pressure controllers extract gas from or fill gas into the pressure control spaces, the pressure controllers can simultaneously detect the pressures in the pressure control spaces and thus drive the flexible light transmissive films to protrude or depress, and that the eyes of the user are effectively massaged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An eye massager, adapted to massage eyes of a user, the eye massager comprising:
a case, comprising an accommodation space and a pressure control space;
a flexible light transmissive film disposed in the case, the flexible light transmissive film covering part of the case to form the pressure control space; and
a pressure controller disposed in the accommodation space, the pressure controller being adapted to detect and adjust a magnitude of a pressure in the pressure control space, wherein when the case covers the eyes of the user, a sealed space is formed among the case, the flexible light transmissive film, and the eyes of the user, a size of the pressure control space compresses or extracts the sealed space, when the pressure controller lowers the pressure in the pressure control space, the flexible light transmissive film depresses towards the pressure control space to increase a volume of the sealed space, and then the eyes of the user are sucked towards the sealed space, and when the pressure controller fills a gas into the pressure control space, the flexible light transmissive film protrudes towards the sealed space and presses the eyes of the user, and then the pressure control space compresses the sealed space and the eyes of the user.

2. The eye massager as claimed in claim 1, further comprising an elastic protection frame surrounding an end of the case, the elastic protection frame being adapted to be in contact with and surround around the eyes of the user to form the sealed space.

3. The eye massager as claimed in claim 2, wherein the elastic protection frame is fixed and connected to the flexible light transmissive film and the case.

4. The eye massager as claimed in claim 2, wherein a material of the elastic protection frame is silicone.

5. The eye massager as claimed in claim 1, wherein a material of the flexible light transmissive film is silicone.

6. The eye massager as claimed in claim 1, further comprising a light emitting element disposed in the accommodation space, a light beam emitted by the light emitting element being adapted to pass through the flexible light transmissive film.

7. The eye massager as claimed in claim 6, wherein a wavelength of the light beam emitted by the light emitting element ranges between 495 nanometers and 570 nanometers.

8. The eye massager as claimed in claim 1, further comprising a processor connected to the pressure controller, wherein the processor sends a control signal to the pressure controller according to the magnitude of the pressure detected by the pressure controller and adjusts the pressure in the pressure control space.

9. The eye massager as claimed in claim 1, wherein when the eye massager covers the eyes of the user, the flexible light transmissive film is located between the case and the eyes of the user.

10. The eye massager as claimed in claim 1, wherein the pressure controller is a pressure transducer.
